(19) United States
(12) Patent Application Publication
(10) Pub. No.: US 2020/0008355 A1
(43) Pub. Date: Jan. 9, 2020

(54) AUTOMATED HARVESTER EFFECTOR

(71) Applicant: METOMOTION LTD., M.P. Misgav (IL)

(72) Inventors: Adi NIR, Sarid (IL); Omer NIR, Sarid (IL)

(21) Appl. No.: 16/493,401

(22) PCT Filed: Mar. 13, 2018
(86) PCT No.: PCT/IL2018/050293

§ 371 Date: Sep. 12, 2019

Related U.S. Application Data
(60) Provisional application No. 62/470,930, filed on Mar. 14, 2017.

(51) Int. Cl. A01D 46/30; A01D 46/24; A01G 3/033; A01G 3/02; B25J 9/16

(52) U.S. Cl. CPC A01D 46/30; A01D 46/24; A01G 3/0335; B25J 9/1679; B25J 9/1697; A01G 2003/023; A01G 3/021

(57) ABSTRACT

An effector coupled to an automated harvesting apparatus, the effector comprising a sensor unit configured to obtain fruit cluster related data relating; a closed kinematic chain mechanism configured: to expand from a closed configuration to an expanded configuration; close from the expanded configuration to the closed configuration; harvesting shears configured to cut the fruit stem, said harvesting shears are coupled to the kinematical closed chain mechanism; a catch mechanism configured to catch the fruit stem after the fruit stem is cut by the harvesting shears; and, a processor configured to operate the effector to cut the fruit stem.

### FIELD OF THE INVENTION

The invention relates to the field of automated robotic harvesting of fruits.

### BACKGROUND

Modern agricultural endeavors provide growing fruits and vegetables in greenhouses in organized structures, e.g. using the trellising growing techniques. For example, vine growing fruits and vegetables may grow in clusters in structures that enable maximizing the amount of produce grown in small areas. To optimize the picking of the produce, many locations make use of automated harvesters.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment an effector coupled to an automated harvesting apparatus, the effector comprising: a sensor unit configured to obtain stem location data relating to a fruit stem of a fruit cluster growing on a plant; a closed kinematic chain mechanism configured: to expand from a closed configuration to an expanded configuration; close from the expanded configuration to the closed configuration; harvesting shears configured to cut the fruit stem, said harvesting shears are coupled to the kinematical closed chain mechanism; a catch mechanism configured to catch the fruit stem after the fruit stem is cut by the harvesting shears; and, a processor configured to operate the effector to cut the fruit stem.

In some embodiments, the closed kinematic chain mechanism comprises at least four arms coupled together with hinges, enabling the closed kinematic chain mechanism to surround the fruit cluster when the closed kinematic chain mechanism is in the expanded configuration.

In some embodiments, the hinges comprise central hinges and a distal hinge to prevent the at least four arms from disconnecting when the closed kinematic chain mechanism is in the expanded configuration.

In some embodiments, the at least four arms provide an opening large enough to enable the fruit cluster to pass through the closed kinematic chain mechanism without fruits of the fruit cluster being damaged by the effector.

In some embodiments, the harvesting shears are coupled to the closed kinematic chain mechanism near a distal hinge to reduce the torque required for cutting the fruit stem;

In some embodiments, harvesting shears are coupled to the closed kinematic chain mechanism at a distal end of the effector.

In some embodiments, the sensor unit is a camera obtaining stem location data as image data of the fruit.

In some embodiments, the effector is coupled to the automated harvester by an automated manipulator, said robotic manipulator configured to: align the effector with the fruit; move the effector to the cutting location on the fruit stem; move the effector to a container in which the fruit is placed after harvesting of the fruit by the effector.

In some embodiments, the robotic manipulator is further configured to align the effector to perform a clean cut of the fruit stem.

In some embodiments, the robotic manipulator is further configured to move along predetermined route to the fruit cluster.

In some embodiments, the processor is further configured to determine a depth dimension of the fruit cluster according to the fruit cluster related data.

In some embodiments, the sensor image comprises a depth image sensor to enable the processor to determine the fruit location.

There is provided, in accordance with an embodiment in which a method comprises using at least one hardware processor of an automated harvester for: Obtaining fruit cluster related data relating to location of a fruit stem of a fruit; determining whether an effector coupled to the automated harvester is at a cutting location along the fruit stem; upon a determination that the effector is at the cutting location, operating the effector to cut the fruit stem at the cutting location.

In some embodiments, the method further comprising: operating a closed kinematic chain mechanism to: configure into an expanded configuration; configure into a closed configuration.

In some embodiments, operating the closed kinematic chain mechanism to configure to the closed configuration generates the necessary torque and force to cut the fruit stem at the cutting location.

In some embodiments, the fruit stem is cut by harvesting shears coupled to the closed kinematic chain mechanism at a distal end of the kinematical closed chain mechanism.

In some embodiments, a catch mechanism is coupled to the closed kinematic chain mechanism catch to the fruit stem after the fruit stem is cut by the harvesting shears.

In some embodiments, the method further comprises operating the closed kinematic chain mechanism to configure to the expanded configuration to release the fruit stem from the catch mechanism.

In some embodiments, the method further comprises operating the catch mechanism to release the fruit stem.

In some embodiments, the method further comprising: operating a robotic manipulator to align the effector with the fruit, wherein the robotic manipulator is coupled to the effector; operating the robotic manipulator to move the effector to a container in which the effector places the fruit.

In addition to the exemplary aspects and embodiments described above, further aspects and embodiments will become apparent by reference to the figures and by study of the following detailed description.

There is provided, in accordance with an embodiment in which, an automated harvester comprising a sensor unit configured to obtain fruit cluster related data relating; a guard effector configured to move branches and obstacles from a fruit stem of a fruit cluster; a harvesting effector configure to cut the fruit stem; a catch mechanism configured to catch the fruit stem after the fruit stem is cut by the harvesting effector; and, a processor configured to operate the guard effector and the harvesting effector to cut the fruit stem.

In some embodiments, the guard effector is coupled to a first robotic manipulator configured to move the guard effector towards the fruit cluster.

In some embodiments, the harvesting effector is coupled to a second robotic manipulator configured to move the harvesting effector towards the fruit cluster to harvest the fruit cluster.

There is provided, in accordance with an embodiment in which, a method comprising using at least one hardware processor of an automated harvester for: obtaining fruit cluster related data relating to location of a fruit stem of a fruit; determining whether an effector coupled to the automated harvester is at a cutting location along the fruit stem; upon a determination that the effector is at the cutting location, operating: a guard effector to remove branches and obstacles from the fruit stem; a harvesting effector to cut the fruit stem.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 schematically illustrates a vine-plant, according to some exemplary embodiments of the subject matter;

FIG. 2 schematically illustrates an automated harvester, according to some exemplary embodiments of the subject matter;

FIG. 3 shows a schematic illustration of an effector of an automated harvest, according to some exemplary embodiments of the subject matter;

FIG. 4 shows a schematic illustration of an automated harvester components, according to some exemplary embodiments of the subject matter;

FIGS. 5A-5G show an effector of an automated harvester harvesting a fruit, according to some exemplary embodiments of the subject matter;

FIG. 6 shows a method for harvesting fruit, according to some exemplary embodiments of the subject matter;

FIGS. 7A-7D show two effectors of an automated harvester harvesting a fruit, according to some exemplary embodiments of the subject matter;

FIG. 8 shows a second exemplary method for harvesting fruit, according to some exemplary embodiments of the subject matter; and,

FIGS. 9A-9B show an open-ended effector of an automated harvester for harvesting a fruit, according to some exemplary embodiments of the subject matter.

### DETAILED DESCRIPTION

The present subject matter relates to an effector coupled to an automatic harvesting apparatus for harvesting a fruit cluster, according to some exemplary embodiments of the subject matter. The effector, which is used to cut and carry the fruit cluster from the plant to a storage container, may be coupled to the automated harvester via a robotic manipulator. The robotic manipulator may manipulate and move the effector to access fruit clusters of fruit growing on a plant. The effector may comprise a kinematical closed chain mechanism, which expands to enable the fruit cluster to pass through while simultaneously protecting the fruit cluster and moving away branches and obstacles. The effector may comprise harvesting shears for cutting the fruit stem connecting the fruit cluster to the plant. After the fruit is cut, a catch mechanism may grab the cut fruit stem and carry the fruit cluster to a container for storage. The automated harvester may comprise sensors, which enable the automated harvester to locate the fruit and to know where to cut the fruit stem to ensure the fruit cluster is harvested and transferred to the container.

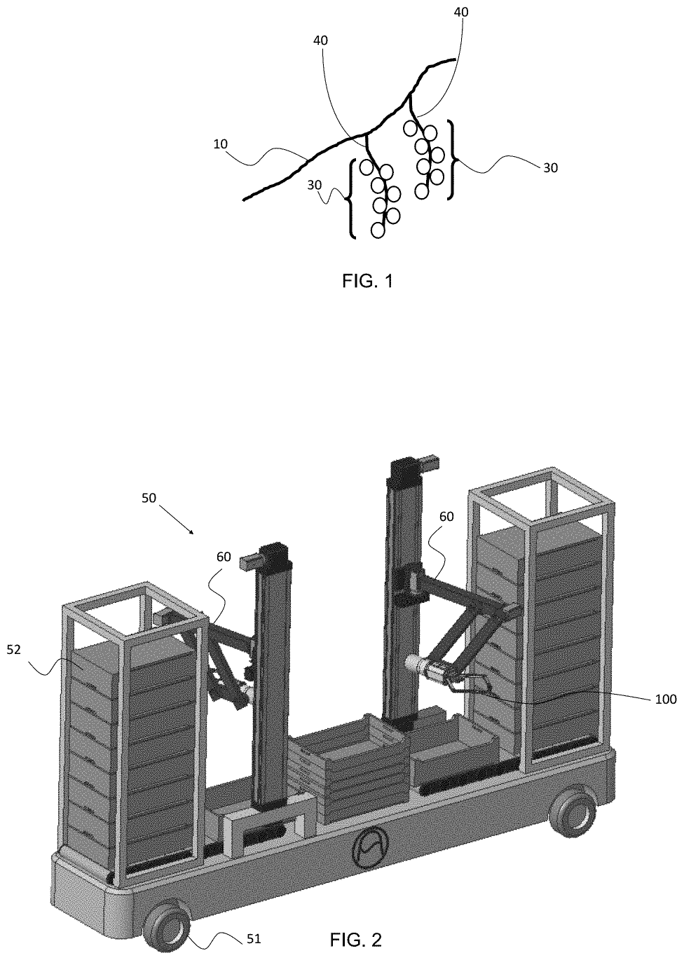

As illustrated in FIG. 1, a vine-plant (“plant”) 10, representing any number of vine-plants 10, may be grown via the trellising growing technique. For example, the plant 10 may be a tomato plant. The plant 10 produces fruit clusters 30, which are connected to the plant 10 via fruit stem 40. The fruit cluster 30, may represent any number of fruit cluster 30 growing on the plant 10, illustrated, for example, as four fruit clusters 30 (hereinafter “fruit cluster”). It is appreciated that while the current disclosure describes fruit clusters, the disclosed subject matter also may be used to harvest a single fruit. The trellising growing technique allows cultivating the plant 10 in greenhouses, thus growing the plant 10 vertically to take advantage of smaller growing areas while maximizing fruit production. Via the trellising growing technique, the plants 10 are organized in well kempt rows, which allows mechanization of the maintenance of the plants 10.

FIG. 2 shows an automated harvester 50 for harvesting fruit cluster 30 from a plant 10, according to some exemplary embodiments of the subject matter. The automated harvester 50 is configured to harvest the fruit cluster 30 from the plant 10 grown in a predetermined arrangement, for example in greenhouses applying a trellising growing technique. The automated harvester 50 may configured to determine a location of the fruit cluster 30 on the plant 10, at which time the automated harvester 50 is configured to harvest the fruit cluster 30. In some exemplary cases, where the plant 10 is grown in a predetermined arrangement, e.g. a vine structure, the plant 10 is organized to grow in organized rows, which enables configuring the automated harvester 50 to travel between the rows to harvest the fruit cluster 30 from the plants 10. Optionally, the automated harvester 50 may comprise wheels 51, for example, for travelling along the rails in between the rows in which the plants 10 grow.

The automated harvester 50 may travel between the rows and harvest the fruit cluster 30 from the plants 10, for example, via a robotic manipulator 60, or any number of robotic manipulators 60, represented herein by two robotic manipulators 60. The automated harvester 50 may comprise containers 52 in which the fruit cluster 30 is placed by the robotic manipulators 60 after being harvested. The robotic manipulator 60 may be coupled to an effector 100, which is configured to harvest the fruit cluster 30. Once the effector 100 has harvested the fruit cluster 30, the effector 100 may be configured to hold the fruit cluster 30, which may enable the robotic manipulator 60 to move the effector 100 and the fruit cluster 30 to a storage, for example the containers 52, in which the fruit cluster 30 may be placed for storage. In some cases, the robotic manipulator 60 moves the effector 100 in a predetermined route to the fruit cluster 30. In such cases, the automated harvester 50 may obtain fruit cluster related data, as disclosed herein in FIG. 4, to optimize the movement of the robotic manipulator 60 ensure that it reaches the fruit cluster 30.

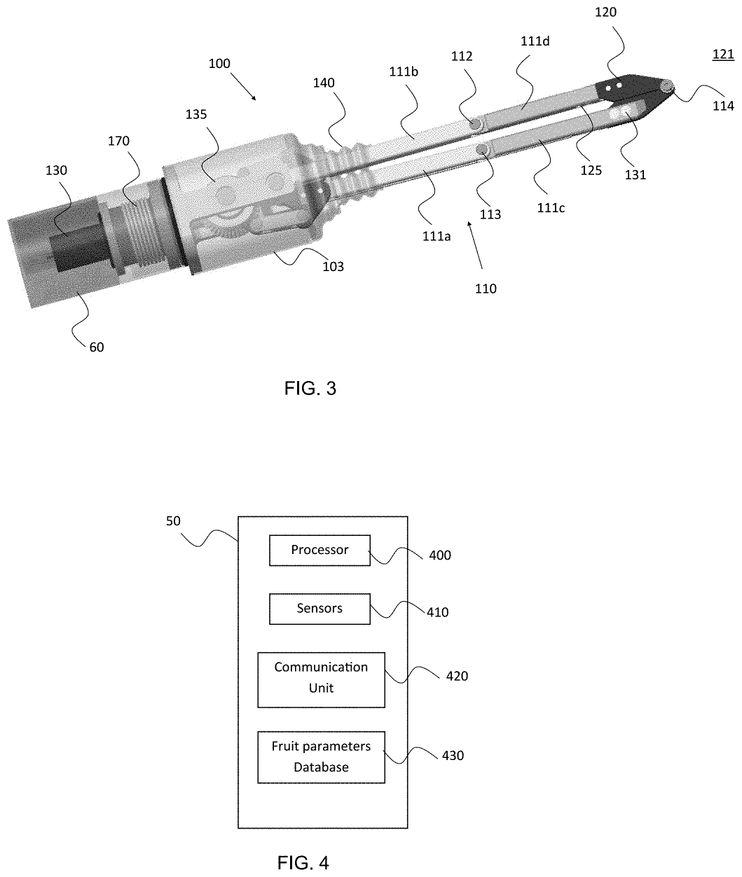

FIG. 3 shows an effector of an automated harvester, according to some exemplary embodiments of the subject matter. The effector 100, may be coupled to the robotic manipulator 60. The effector 100 may comprise a closed kinematic chain mechanism 110, which may be configured to open and close during the effector's motion to reach the fruit stem 40 during harvesting of the fruit cluster 30. The closed kinematic chain mechanism 110 may be coupled to a motor 105, which operates the motion of the closed kinematic chain mechanism 110. Optionally, the motor 105 is coupled to a transmission 135, which may couple the motor 105 to the closed kinematic chain mechanism 110. In examples, the transmission 135 controls the movement of the closed kinematic chain mechanism 110, for example, moving the closed kinematic chain mechanism 110 from a closed configuration to an expanded configuration and vice versa.

In some exemplary embodiments, the closed kinematic chain mechanism 110 may comprise arms, four example four arms, represented herein by 111a, 111b, 111c, 111d. The arms may be coupled together via hinges, for example, center hinges 112, 113, and distal hinge 114. The center hinges 112, 113, and distal hinge 114 may enable the closed kinematic chain mechanism 120 to expand without the arms disconnecting from each other, thus surrounding the fruit cluster 30 while simultaneously moving away branches and obstacles. Optionally, the arms may be rigid, flexible, or the like. In some cases, the hinges are coupled to the arms in locations, enabling the closed kinematic chain mechanism 110 to expand in various shapes in the expanded configuration to enable the fruit cluster 30 to pass through an opening of the closed kinematic chain mechanism 110. When the effector 100 moves towards the fruit stem 40, the robotic manipulator 60 may align the effector 100 in a predetermined orientation relative to the fruit cluster 30, for example, parallel along a vertical axis to the fruit cluster 30, such that the fruit cluster 30 passes in between the arms of the closed kinematic chain mechanism 110 as the effector 100 moves to reach the fruit stem 40. The effector 100 comprises a stem sensor 125, which is configured to detect the fruit stem 40.

In some cases, the effector 100 may comprise a flexible rolling joint 170, which enables the effector 100 to align in a parallel arrangement with the fruit cluster 30 to cut with fruit stem 40 with a clean cut to prevent unwanted damage to the plant 10. In some cases, the closed kinematic chain mechanism 110 may be configured with different sized arms 111a, 111b, 111c, 111d and harvesting shears 120 to enable harvesting different types of fruits. In some exemplary embodiments, the effector 100 may comprise a casing 103 for storing the motor 105 and transmission 135. Optionally, the effector 100 comprises a flexible seal 140 for covering the closed kinematic chain mechanism 110 where the closed kinematic chain mechanism 110 is coupled to the transmission 135, while providing the necessary mobility for the closed kinematic chain mechanism 110 to open and close as necessary to harvest the fruit cluster 30. Optionally, the closed kinematic chain mechanism 110 cross section expands according to the dimensions of the fruit cluster 30 and the fruit in the fruit cluster 30. For example, the cross-section may be 300 mm for a fruit cluster 30 with fruit having a diameter of 25-35 mm and the fruit cluster 30 consists of two rows of fruit. In such an example, the closed chain mechanism 110 may have a length within a range of 70-75 mm.

In some exemplary embodiments, the closed kinematic chain 110 may not completely be closed, e.g. have an opening between the arms 111a, 111b, 111c, 111d. The opening may enable the fruit stem 40 to enter the opening of the closed kinematic chain 110 without requiring the fruit cluster 30 to pass through the opening of the closed kinematic chain 110 to enable the harvesting shears 120 to access the fruit stem 40.

FIG. 4 illustrates a schematic representation of an automated harvesting apparatus, according to some exemplary embodiments of the subject matter. The automated harvesting apparatus 100 comprises a processor 200, which operates the components of the automated harvester 50, e.g. the automated mobilizer 60 and the effector 100. For example, the processor 200 operates the motor 130 thus operating the transmission 135 and the closed kinematic chain mechanism 110. The processor 400 is coupled to one or more sensors 410, which are configured to obtain fruit cluster related data, which provides data enabling the processor to determine a location of the fruit cluster 30, for example, image data of the plant 10 and the fruit cluster 30. Optionally, the fruit cluster related data enables the processor 40 to determine whether the fruit cluster 30 comprises predetermined parameters for harvesting, for example, ripeness. In some cases, the one or more sensors 410 may comprise a depth image sensor, a range sensor, or the like, to provide accurate location data of a fruit cluster location. In some cases, the one or more sensors 410 comprises the stem sensor 125, which is configured to provide an indication to the processor 400 that the fruit stem 40 is located near the harvesting shears for harvesting. For example, the stem sensor 125 is an infrared (“IR”) sensor which provides the indication when the fruit stem 40 crosses the path of the stem sensor 125. In examples, the processor 400 analyzes the location data received from the one or more sensors 410 to determine the location of the fruit cluster 30, so to mobilize the effector 100 to the fruit cluster 30 location to enable harvesting of the fruit cluster 30. The processor 400 may be configured to determine when the closed kinematic chain mechanism 110 is between fruits of the fruit cluster 30, in which case, if the closed kinematic chain mechanism 120 is closed to the closed configuration not all of the fruits of the fruit cluster 30 will be harvested, and when the closed kinematic chain mechanism 110 has reached the fruit stem 40 and closing of the closed kinematic chain mechanism 110 to the closed configuration results in harvesting the entire fruit cluster 30. The processor 400 may differentiate between the stems according to the stem data obtained from the one or more sensors 410, e.g. the stem sensor 125.

The aforementioned detection of the fruit cluster 40 and a fruit cluster's predetermined parameters for harvesting, for example ripeness, may be done via the sensor unit 410 coupled to the processor 400, which is configured to run known computer-vision algorithms. Optionally, these computer-vision algorithms may be classic computer-vision segmentation functions using, for example, edge-detection algorithms like Sobel, Canny, Prewitt, Roberts, and other fuzzy logic methods. Option ally the algorithms may include an Active contour model, or the like. Optionally, blob detection algorithms such as Laplacian of Gaussian or determinant of the Hessian may be used, and of course spectral content methods, based on the specific color-content of ripe fruit. Optionally, in cases where the variability of the scene is large, the processor 400 may be configured to shift from classic computer-vision segmentation functions to machine learning techniques using deep neural networks trained on the high availability of training images of fruit clusters.

In some exemplary embodiments of the subject matter, once processor 400 has detected the fruit-cluster, the processor 400 may perform an image analysis by an algorithm to extract a depth-map of the area surrounding a detected fruit cluster according to data obtained from the sensor unit 410. This depth-map may be obtained by any suitable computer-vision technique, for example: Depth from stereo, structured light, time-of-flight, or the like. The sensing unit 410 may comprise additional types of range sensing devices e.g. LIDAR, IR, or ultra-sonic transceiver, or the like.

Optionally, a depth-map may be produced by the processor 400 according to the above computer-vision algorithms. Once the depth map is produced, the processor 400 may analyze the depth map to determine, for example, fruit cluster boundaries, a geometric center, overall size, extreme-points, or the like. Moreover, any obstacles around the fruit-cluster 40 may be detected and mapped. Optionally, the determination may be transformed to data used by the processor 400 to operate the closed kinematic chain mechanism 120 guiding it to the fruit-cluster 40 and to perform the harvesting of the fruit cluster 40 as described herein.

In some cases, the processor 400 determines a depth of the fruit cluster 30 according to the data obtained from the sensor unit 410. The processor 400 may determine the depth according to the diameter of fruit in the fruit cluster 30 and according to the alignment of the fruit cluster in the fruit cluster related data obtained by the sensor unit 410. For example, where the fruit cluster related data is obtained as an image, in which the fruit cluster 30 appears as a single row of fruit where the fruit cluster 30 is known to consist of two rows, the processor 400 is configured to determine that a second row of fruit of the fruit cluster 30 is behind the first row, hidden from the sensor unit 410. According to the determination, the processor 400 determines that the depth of the fruit cluster 30 is twice the depth when the two rows of fruit of the fruit cluster 30 are identified in the image data obtained.

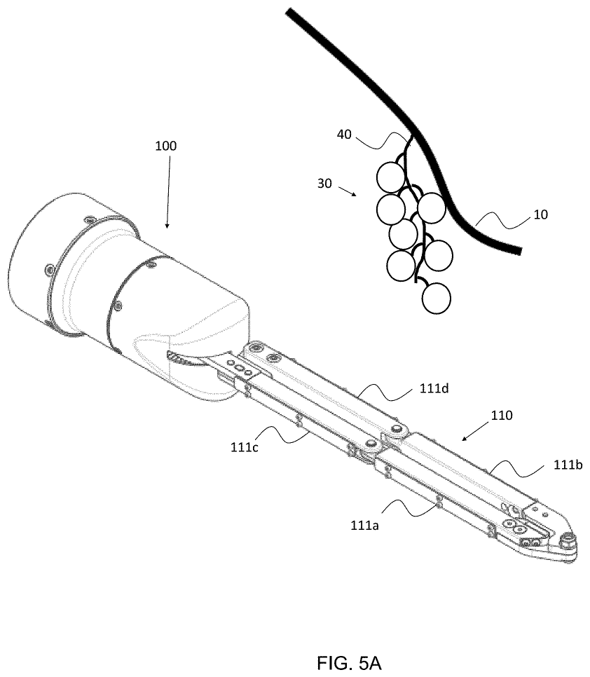

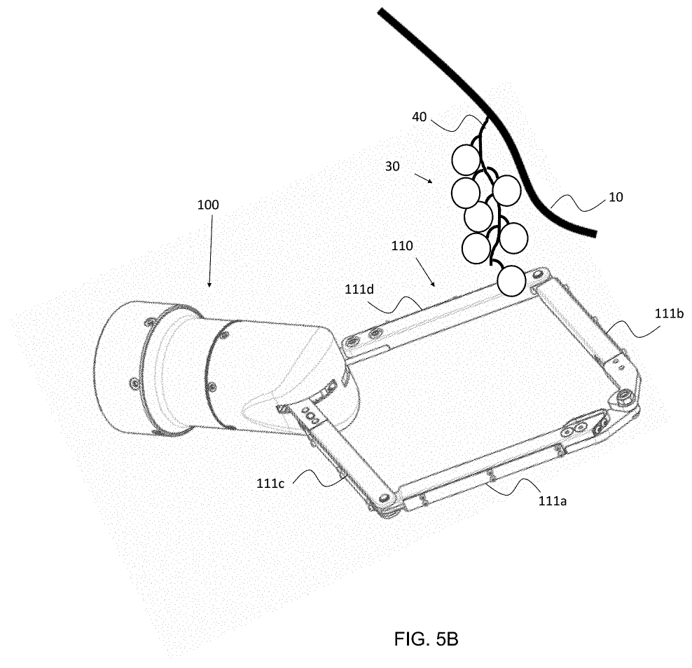

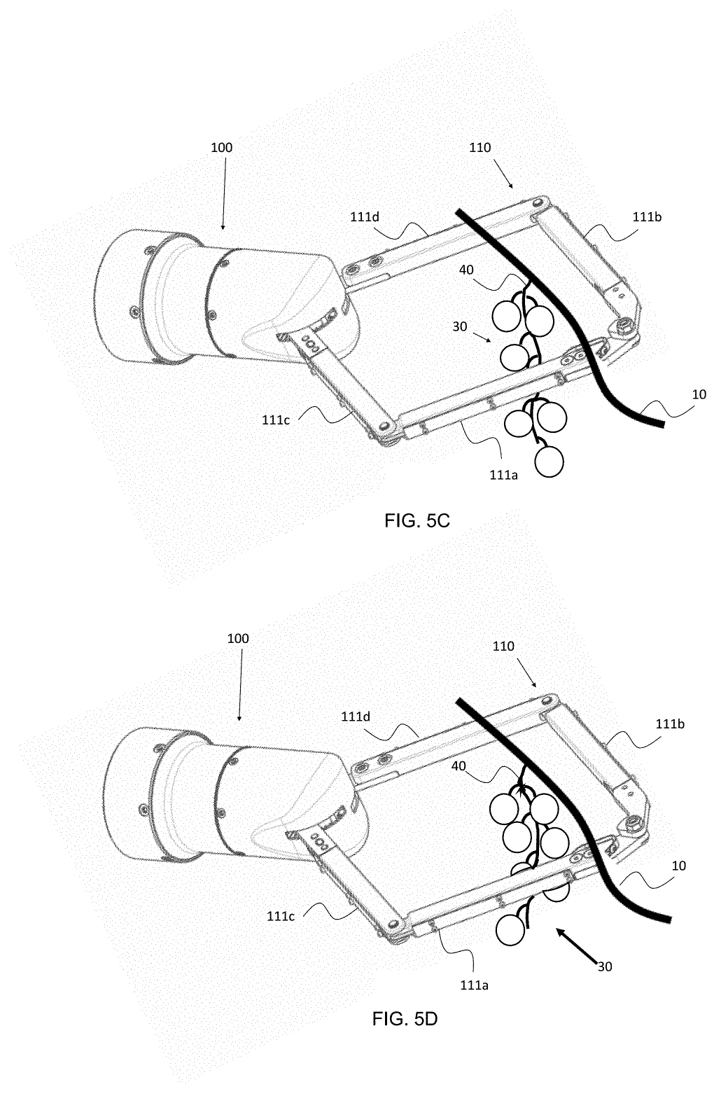

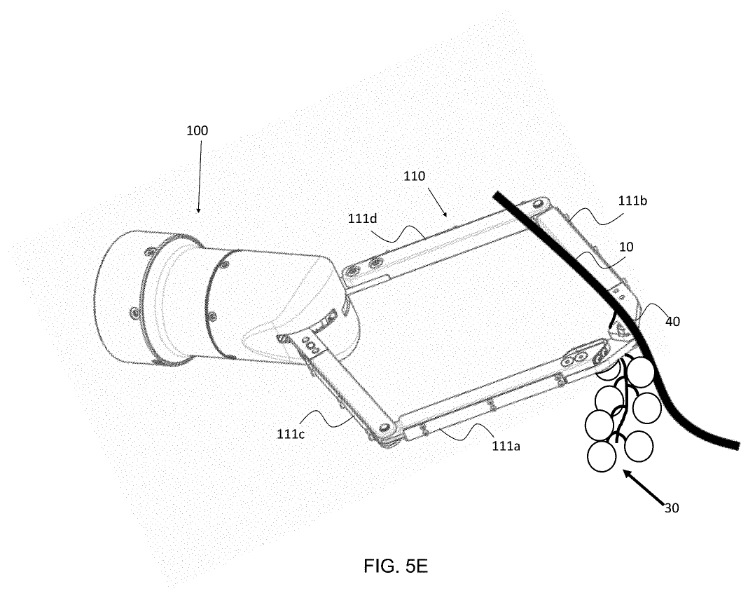

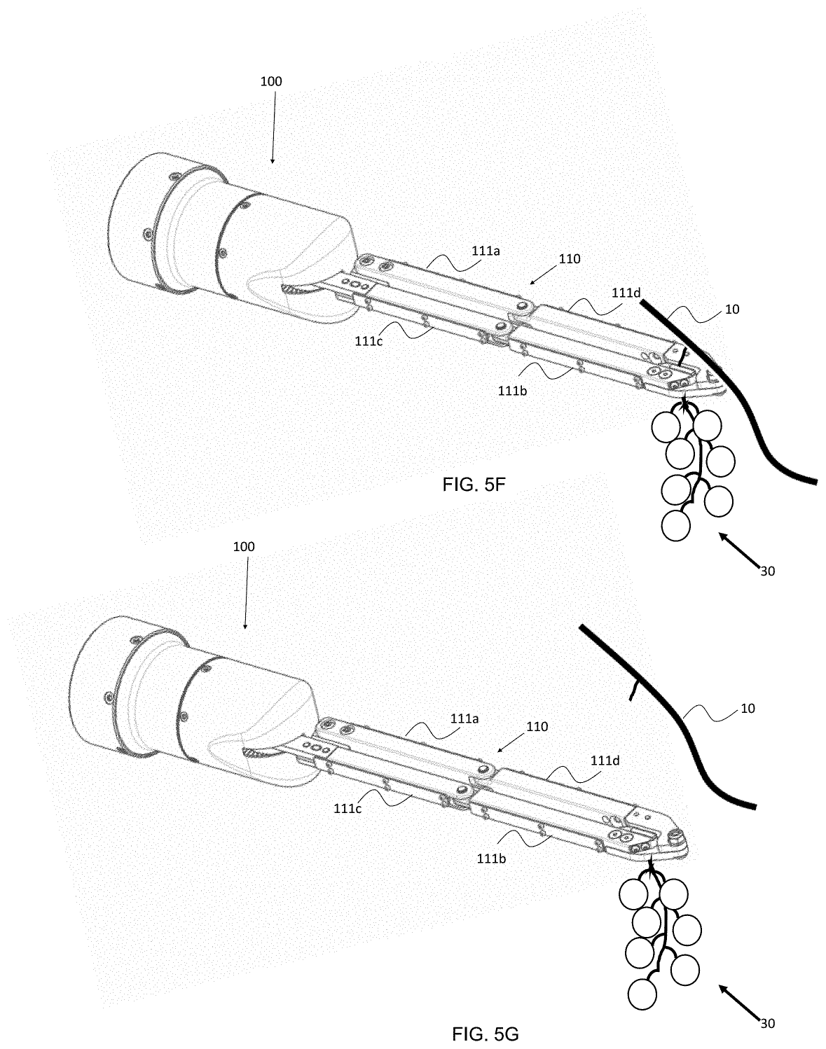

FIG. 5A-5G show an effector of an automated harvest apparatus, according to some exemplary embodiments of the subject matter. The effector 100 may be configured to access the fruit stem 40 without damaging the fruit cluster 30 and nearby plant parts, such as other fruit clusters, leaves, and the main stem.

In FIG. 5A, the effector 100 approaches the fruit cluster 30, for example, along a predetermined path, for example according to the image processing and analysis described above herein. The closed kinematic chain mechanism 110 may be arranged in a closed configuration to enable moving in a most efficient pattern towards the fruit cluster 30 with a minimal cross-section. For example, upon determining according to the processing of the fruit related data as described above herein, and upon determining the location of the fruit cluster 30, the effector 100 is moved towards the fruit cluster 30 via the robotic manipulator 60. As the effector 100 is moved towards the fruit cluster 30, the arms of the closed kinematic chain mechanism 110 are configured in a closed configuration to provide a minimal cross section to the effector 100. The minimal cross section minimizes the chance of the effector 100 entangles with branches of the plant 10 or other obstacles.

In FIG. 5B, the closed kinematic chain mechanism 110 is configured to expand into an expanded configuration to enable the fruit cluster 30 to pass between the arms 111a, 111b, 111c, 111d of the closed kinematic chain mechanism 110 without the fruits of the fruit cluster being damaged. For example, upon reaching a predetermined point beneath the fruit cluster 30, the closed kinematic chain mechanism 110 expands to the expanded configuration. After being configured in the expanded configuration, the robotic manipulator 60 raises the effector 100 with the closed kinematic chain mechanism 110 in the expanded configuration such that the arms 111a, 111b, 111c, 111d surround the fruit cluster 30 and remove branches and obstacles from the fruit cluster 30.

In FIG. 5C shows the closed kinematic chain mechanism 110 in the expanded configuration moving towards the fruit stem 110, according to some exemplary embodiments of the subject matter. As the effector 100 is moved towards the fruit stem 40, the sensor unit 410 may continuously obtain fruit related data, e.g. location data to determine the closed kinematic chain mechanism 110 maintains the route to the fruit stem 40. As the closed kinematic chain mechanism 110 moves, it may remove branches and obstacles from the fruit cluster 30. Optionally, the arms 111a, 111b, 111c, 111d may be configured to be expanded exactly according to the size of the fruit cluster 30 according to the analysis of the fruit related data. The arms 111a, 111b, 111c, 111d may be expanded according to the determination of a width of the fruit cluster, the depth of the fruit cluster, for example, when the fruit related data is image data obtained by the sensor unit 410. The image data may be analyzed to determine the parameters, e.g. height, width, depth, or the like, of the fruit cluster 30 and of each fruit in the fruit cluster 30.

FIG. 5D shows the closed kinematic chain mechanism 110 is aligned with the fruit stem 40, according to some exemplary embodiments of the subject matter. Optionally, the alignment is obtained according to the fruit related data obtained via the sensor unit 410.

FIG. 5E shows the closed kinematic chain mechanism 110 in a cutting arrangement, according to some exemplary embodiments of the subject matter. Optionally, upon the effector 110 reaching the fruit stem 40, e.g. according to a predetermined route and location data determined from the fruit related data as described above, the effector 100 may then be moved to a cutting position. The cutting position may be achieved by the robotic manipulator 60 performing a predetermined motion, for example aligning the fruit stem 40 with the harvesting shears 120. A determination that the fruit stem 40 is at a cutting location may be according to a stem sensor 125, which may detect when the fruit stem 40 is aligned with the harvesting shears 120. The stem sensor 125 may detect the fruit stem 40, for example, as an infrared (“IR”) sensor, which may detect when the fruit stem 40 crosses a path of the IR sensor. The stem sensor 125 may provide the stem data, e.g. the detection that the fruit stem reached the cutting location, to the processor 400 to determine when the closed kinematic chain mechanism 110 is aligned with the cutting location along the fruit stem 40. The stem data enables the processor 400 to determine that the harvesting shears 120 are at the cutting location, thus ensuring that the fruit stem 40 that is being cut and thus avoid cutting other branches, stems or objects that might be vital to the plant's survival.

FIG. 5F shows the closed kinematic chain mechanism 110 closed to a closed configuration, according to exemplary embodiments of the subject matter. Optionally, when the closed kinematic chain mechanism 110 closes to the closed configuration, the harvesting shears 120 cut the fruit stem 40, which results in the harvesting of the fruit cluster.

FIG. 5G shows the effector 100 catching the fruit cluster 30, according to some exemplary embodiments of the subject matter. For example, after the harvesting shears 120 cut the fruit stem, the catch mechanism 125 may catch the fruit stem 40 and holds it, while the robotic manipulator 60 moves the effector 100 to a location where the fruit cluster 30 is stored, e.g. the container 52.

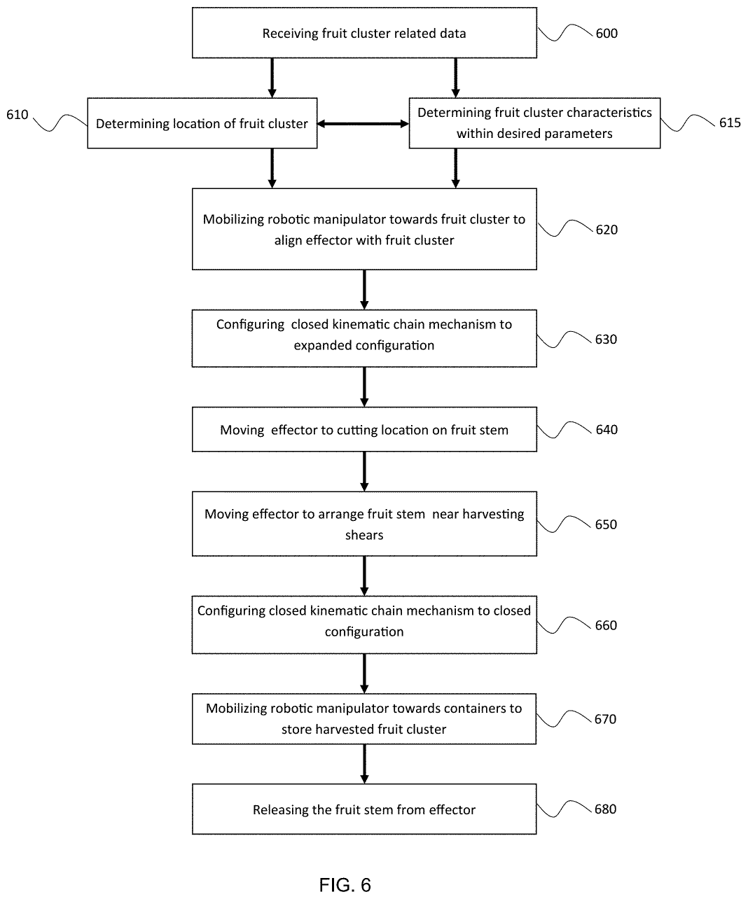

FIG. 6A-6B show a method for harvesting fruit, according to some exemplary embodiments of the subject matter. FIG. 6A shows a method for operating the automated harvester 50 to harvesting and store the fruit cluster 30, according to some exemplary embodiments. Step 600 discloses receiving fruit cluster related data. For example, the fruit related data is image data obtained by the sensor unit 410.

Step 610 discloses determining the location of the fruit cluster 30. The processor 400 performs an analysis of the fruit related data received from the sensors 410, for example, by applying STIF, SURF, or ORB algorithms for identifying the fruit cluster 30 in the fruit related data as described above.

Step 615 discloses determining whether fruit cluster characteristics are within predetermined parameters. In some cases, the processor 400 analyzes the fruit cluster related data to determine the predetermined parameters, for example, ripeness of the fruit in the fruit cluster 30, the size of the fruit in the fruit cluster 30, the size of the fruit cluster 30 or the like. In some exemplary embodiments, the processor 400 determines the depth of the fruit cluster 30 to enable the automated harvester 50 to determine the size of the fruit cluster 30 and thus open the effector 100 to the necessary size to not damage the fruit cluster 30 during harvesting.

Step 620 discloses mobilizing the robotic manipulator 60 towards the fruit cluster 40 to align the effector 100 with the fruit cluster 30. The robotic manipulator 60 is mobilized towards the fruit cluster 30 so that the effector 100 is aligned with the fruit cluster 30. For example, the effector 100 is along a same vertical axis as the fruit cluster 30. Upon alignment of the effector 100 with the fruit cluster 30, the robotic manipulator 60 is operated by the processor 400 to vertically move the effector 100 to access the fruit stem 40 as further disclosed herein in FIG. 6B below.

Step 630 discloses configuring the closed kinematic chain mechanism to the expanded configuration. The effector is moved towards the fruit cluster 30, e.g. the automated harvester 50 moves the manipulator 60 towards the fruit cluster 30 according to the location data. The effector is 100 aligned with the fruit cluster 30, for example, parallel to the fruit cluster 30. The closed kinematic chain mechanism 110 expands to the expanded configuration to enable the closed kinematic chain mechanism 110 to encompass the fruit cluster 30 between the arms of the closed kinematic chain mechanism 110, which enables moving away branches and obstacles from the fruit cluster 30.

Step 640 discloses moving effector to a cutting location on the fruit stem 40.

Step 650 discloses moving the effector 100 (for example, horizontally) to arrange the fruit stem 40 near harvesting shears 120. Upon reaching the fruit stem 40, the robotic manipulator 60 moves the effector 100 such that the fruit stem 40 is near the harvesting shears 120, to enable the harvesting of the fruit cluster 30. In some cases, where the harvesting shears 120 are arranged near the distal hinge 114, the effector 100 is moved until the fruit stem 40 is positioned between the shears of the harvesting shear 120.

Step 660 discloses configuring the closed kinematic chain mechanism 120 to the closed configuration. The processor 400 configures the effector 100 to close the closed kinematic chain mechanism 110 to result in cutting of the fruit stem 40 by the harvesting shears 120. By example, the processor 400 activates the motor 130, which closes the closed kinematic chain mechanism 110 to a closed configuration. When the closed kinematic chain mechanism 110 is in the closed configuration, the fruit stem 40 is caught by the catch mechanism 131.

Step 670 discloses mobilizing the robotic manipulator 60 towards containers 52 to store harvested fruit cluster. As the robotic manipulator 60 moves towards the containers 52 while the fruit cluster 30 is carried by the effector 100 via the catch mechanism 131 holding the fruit stem 40.

Step 680 discloses releasing the fruit stem 40 from the effector 100. In examples, the fruit stem 40 may be released from the catch mechanism 131 by the closed kinematic chain mechanism 110 configured to the expanded configuration, which releases the fruit stem 40 from the catch mechanism 131. Another example, the catch mechanism 131 has a release mechanism which is engaged by the processor 400, which releases the fruit stem 40.

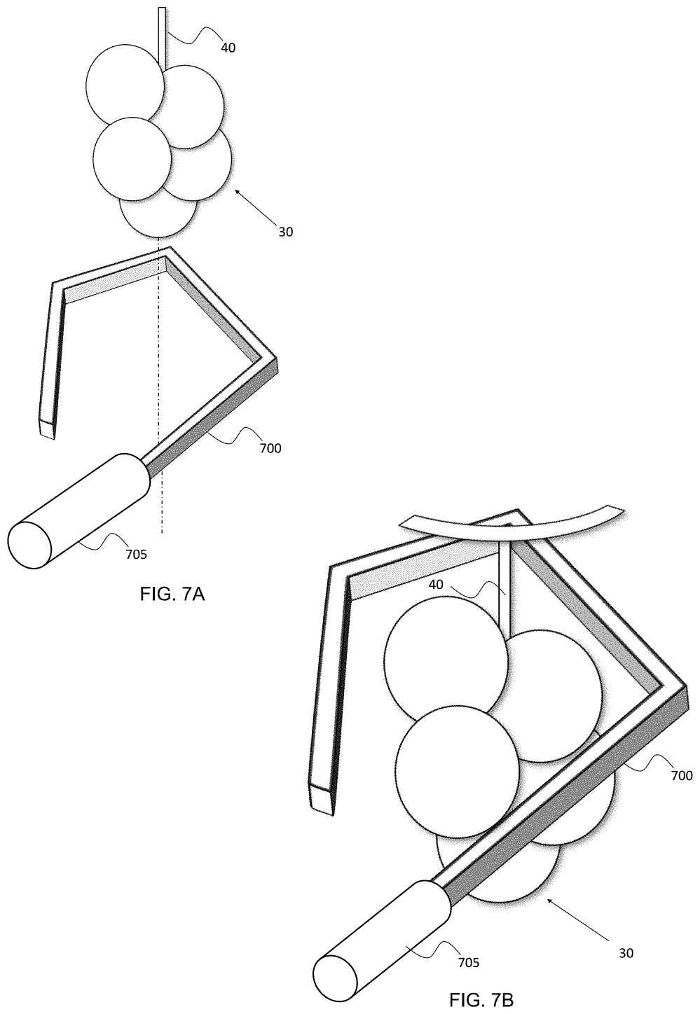

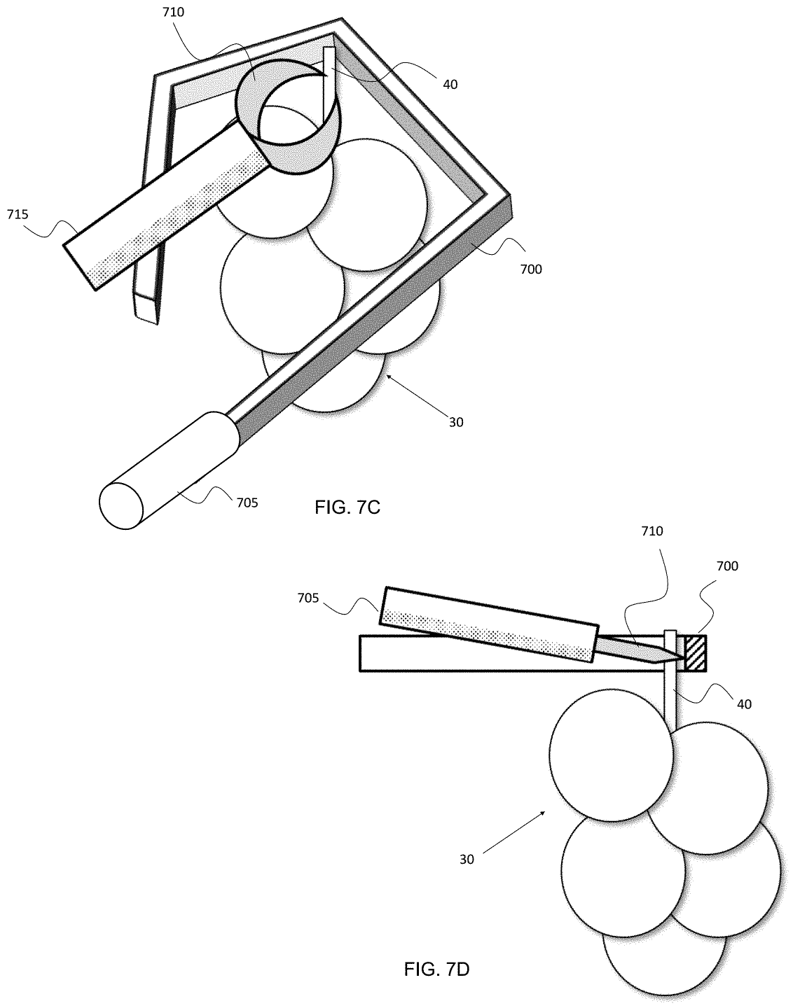

FIG. 7A-7C show two effectors of an automated harvester harvesting a fruit, according to some exemplary embodiments of the subject matter. FIG. 7A shows a guard effector 700 being moved towards the fruit cluster 30, according to some exemplary embodiments of the subject matter. The guard effector 500 may be coupled to a first robotic manipulator 705 of the automated harvester 50. The guard effector 500 may be moved to guard the fruit cluster 30 and ma also move away other branches and obstacles from near the fruit cluster 30. The guard effector 700, may be a shaped as a metal plate, a hook, or the like. The guard effector 700 may be moved towards the fruit according to the methods disclosed herein above, e.g. via image data obtained of the fruit cluster 30.

FIG. 7B shows a harvesting effector 710 approaching the fruit stem 40, according to some exemplary embodiments of the subject matter. In some cases, after the guard effector 700 reaches the location where it removed branches and obstacles from the fruit stem 40, the automated harvester 50 may mobilize a second robotic manipulator 715 to mobilize the harvesting effector 710 towards the fruit stem 40.

FIG. 7C shows the harvesting effector 710 harvesting the fruit cluster 30, according to some exemplary embodiments of the subject matter. In some exemplary embodiments of the subject matter, the guard effector 700 and the harvesting effector 710 may be combined to one effector, which has a guard element and a harvesting element. In such an exemplary embodiment, the guard element may move branches and obstacles from the fruit stem 40 and latch the fruit stem 40. The harvesting element may be extended towards the fruit stem 40 to harvest the fruit stem 40.

Referring to FIG. 7D showing a side view of the two effectors harvesting the fruit cluster 30, according to exemplary embodiments. The harvesting effector 710 may be operated, e.g. the processor 400, to be arranged towards the location where the guard effector 700 is adjacent to the fruit stem 40.

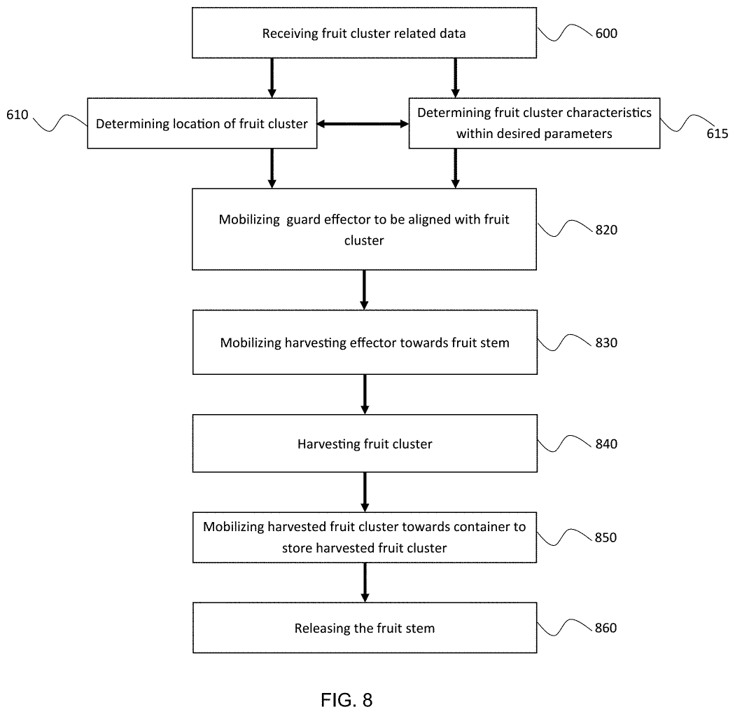

FIG. 8 shows a second exemplary method for harvesting fruit, according to some exemplary embodiments of the subject matter. Similar to the method disclosed herein in FIG. 6, the method disclosed herein may perform steps 600, 610 and 615 as disclosed above herein. Step 830 discloses mobilizing the guard effector 700 to be aligned with the fruit cluster 30. In some cases, the guard effector 700 is mobilized, via the first robotic manipulator 705 towards the fruit cluster 30. Likewise, the guard effector 700 may be mobilized specifically towards the fruit stem 40 to move branches and obstacles from the fruit stem 40 to enable harvesting the fruit cluster 30.

Step 830 discloses mobilizing the harvesting effector 710 towards the fruit cluster 40. The harvesting effector 710 may be mobilized via the second robotic manipulator 715 towards the fruit stem 40.

Step 840 discloses harvesting the fruit cluster 30. The harvesting cluster 710 may, upon reaching the fruit stem 40, be operated by the automated harvester 50, e.g. the processor 400, to harvest the fruit cluster 30 by cutting the fruit stem 40. Upon cutting of the fruit stem 40, the fruit stem 40 may be caught by the catch mechanism, which may be coupled to either the harvesting effector 710 or may be coupled to the guard effector 700.

Step 850 discloses mobilizing harvested fruit cluster towards the container 52 to store the harvested fruit cluster. The fruit cluster 30 that was harvested may be held by the catch mechanism, which may be coupled to either the harvesting effector 710 or the guard effector 700.

Step 860 discloses releasing the fruit stem 40. Upon reaching the container 52, the catch mechanism may release the fruit cluster 30, e.g. releasing the fruit stem 40, to place the harvested fruit cluster into the container 52.

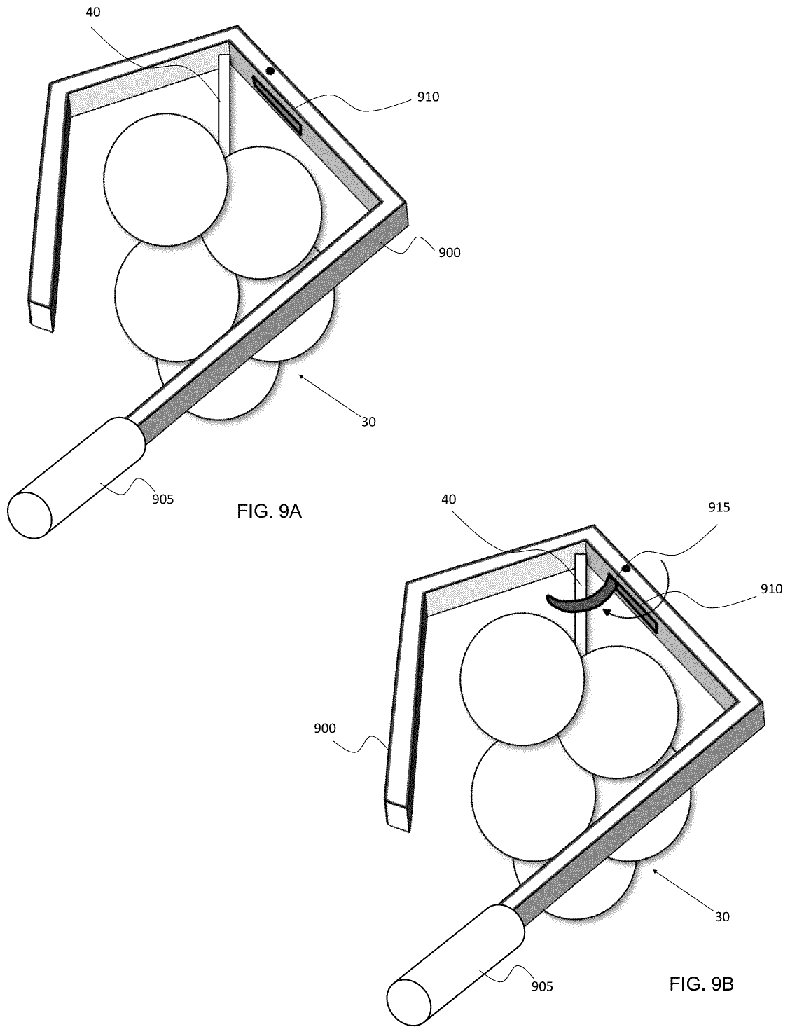

FIG. 9A-9B shows an open-ended effector of an automated harvester for harvesting a fruit, according to some exemplary embodiments of the subject matter.

Referring to FIG. 9A, showing an open-ended effector 900 approaching a fruit cluster 30, according to some exemplary embodiments of the subject matter. The open-ended effector 900 may be moved via a robotic manipulator 905. Referring to FIG. 9B, showing the open-ended effector 900 harvesting the fruit cluster 30, according to some exemplary embodiments of the subject matter. The open-ended effector 900 may comprise an extractable shear 915 for harvesting the fruit cluster 30, e.g. by cutting the fruit stem 40. Optionally, the extractable shear 915 is stored in a storage compartment 910, which may be a portion of the open-ended effector 900.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An effector coupled to an automated harvesting apparatus, the effector comprising:
a sensor unit configured to obtain fruit cluster related data relating to location of a fruit stem of a fruit;
a closed kinematic chain mechanism configured:
to expand from a closed configuration to an expanded configuration;
close from the expanded configuration to the closed configuration;
harvesting shears configured to cut the fruit stem, said harvesting shears are coupled to the kinematical closed chain mechanism;
a catch mechanism configured to catch the fruit stem after the fruit stem is cut by the harvesting shears; and,
a processor configured to operate the effector to cut the fruit stem.

2. The effector of claim 1, wherein said closed kinematic chain mechanism comprises at least four arms coupled together with hinges, enabling the closed kinematic chain mechanism to surround the fruit cluster when the closed kinematic chain mechanism is in the expanded configuration.

3. The effector of claim 2, wherein the hinges comprises central hinges and a distal hinge to prevent the at least four arms from disconnecting when the closed kinematic chain mechanism is in the expanded configuration.

4. The effector of claim 2, wherein the at least four arms provide an opening large enough to enable the fruit cluster to pass through the closed kinematic chain mechanism without fruits of the fruit cluster being damaged by the effector.

5. The effector of claim 2, wherein the harvesting shears are coupled to the closed kinematic chain mechanism near a distal hinge to reduce the torque required for cutting the fruit stem;

6. The effector of claim 1, wherein the harvesting shears are coupled to the closed kinematic chain mechanism at a distal end of the effector.

7. The effector of claim 1, wherein the sensor unit is a camera obtaining stem location data as image data of the fruit.

8. The effector of claim 1, wherein the effector is coupled to the automated harvester by an automated manipulator, said robotic manipulator configured to:
align the effector with the fruit;
move the effector to the cutting location on the fruit stem;
move the effector to a container in which the fruit is placed after harvesting of the fruit by the effector.

9. The effector of claim 8, wherein the robotic manipulator is further configured to align the effector to perform a clean cut of the fruit stem.

10. The effector of claim 8, wherein the robotic manipulator is further configured to move along predetermined route to the fruit cluster.

11. The effector of claim 1, wherein the processor is further configured to determine a depth dimension of the fruit cluster according to the fruit cluster related data.

12. The effector or claim 1, wherein the sensor image comprises a depth image sensor to enable the processor to determine the fruit location.

13. A method comprising using at least one hardware processor of an automated harvester for:
obtaining fruit cluster related data relating to location of a fruit stem of a fruit;
determining whether an effector coupled to the automated harvester is at a cutting location along the fruit stem;
upon a determination that the effector is at the cutting location, operating the effector to cut the fruit stem at the cutting location.

14. The method of claim 13, further comprising:
operating a closed kinematic chain mechanism to:
configure into an expanded configuration;
configure into a closed configuration.

15. The method of claim 13, wherein operating the closed kinematic chain mechanism to configure to the closed configuration generates the necessary torque and force to cut the fruit stem at the cutting location.

16. The method of claim 13, wherein the fruit stem is cut by harvesting shears coupled to the closed kinematic chain mechanism at a distal end of the kinematical closed chain mechanism.

17. The method of claim 16, wherein a catch mechanism is coupled to the closed kinematic chain mechanism catch to the fruit stem after the fruit stem is cut by the harvesting shears.

18. The method of claim 13, further comprising operating the closed kinematic chain mechanism to configure to the expanded configuration to release the fruit stem from the catch mechanism.

19. The method of claim 18, further comprising operating the catch mechanism to release the fruit stem.

20. The method of claim 13, further comprising:
operating a robotic manipulator to align the effector with the fruit, wherein the robotic manipulator is coupled to the effector;
operating the robotic manipulator to move the effector to a container in which the effector places the fruit.

21. An automated harvester comprising:
a sensor unit configured to obtain fruit cluster related data relating to location of a fruit stem of a fruit;
a guard effector configured to move branches and obstacles from a fruit stem of a fruit cluster;
a harvesting effector configure to cut the fruit stem;
a catch mechanism configured to catch the fruit stem after the fruit stem is cut by the harvesting effector; and,
a processor configured to operate the guard effector and the harvesting effector to cut the fruit stem.

22. The automated harvester of claim 21, wherein the guard effector is coupled to a first robotic manipulator configured to move the guard effector towards the fruit cluster.

23. The automated harvester of claim 22, wherein the harvesting effector is coupled to a second robotic manipulator configured to move the harvesting effector towards the fruit cluster to harvest the fruit cluster.

24. (canceled)
